(19) United States
(12) Patent Application Publication
(10) Pub. No.: US 2009/0242362 A1
(43) Pub. Date: Oct. 1, 2009

(54) UNGUIDED BALLISTIC WARHEAD FUSE SWITCHING DEVICE

(76) Inventor: Wilbur Dale Jones, Rio Rancho, NM (US)

Correspondence Address: Dale Jones, 3520 Greystone Ridge Ct, SE, Rio Rancho, NM, 87124, US

(21) Appl. No.: 11/975,341

(22) Filed: Oct. 19, 2007

(51) Int. Cl. H01H 35/14

(52) U.S. Cl. 200/61.53

(57) ABSTRACT

The invention is an acceleration switch designed to fuse switch unguided ballistic warheads at a specified elevation above land. It houses two spring controlled and inertia responsive electrically conductive pistons, one of which would electrically program the fuse switching acceleration value when advancing, upon sensing peak acceleration (as the reentering warhead experiences its peak deceleration), and the other of which would close the fuse switching circuit when, upon retracting, it senses the programmed fuse switching acceleration value. The switch also incorporates a remotely steppable bi-directional stepping motor which would be employed to regulate the inactive position of the fuse switching piston.

### BACKGROUND OF THE INVENTION

The arming and fusing (A&F) system of unguided ballistic warheads is intended to fuse switch the warheads at a specified elevation above target. The need for replacing our multi-component A&F system is evidenced by its failure rate and the exorbitant expense of its maintenance. Twenty-five dummy warheads equipped with this system were tested. Reportedly, over one-half (between 13 and 25) of the tests were failures. The present invention is a highly reliable and accurate device designed to replace this A&F system.

### SUMMARY OF THE INVENTION

In operation, an unguided ballistic warhead would, upon reentering earth's atmosphere, first experience deceleration increasing to a peak value, afterwhich the warhead's deceleration would decrease as it continues to descend. The fuse switching function would be required when the warhead reaches a specified elevation above land. Different warhead trajectories would involve different peak and respective fuse switching deceleration values. Thus the present invention, designed to effect the fuse switching function, is an acceleration switch which incorporates two spring-controlled warhead deceleration responsive pistons, one of which would sense peak warhead deceleration and electrically program the respective warhead fuse switching value and the other of which would close the fuse switching circuit when sensing, during its retraction, the programmed fuse switching value. The acceleration switch also houses a remotely programmable bi-directional stepping motor which would be employed to regulate the rest position of the fuse switching piston in accordance with possible difference between the invention's automatically programmed and respective expected actual warhead fuse switching deceleration values.

### IN THE DRAWINGS

FIG. 1 is a side elevation view of the invention, with certain parts broken away.

FIG. 2 is a graphic illustration of the relationship of a representative unguided ballistic warhead's reentry peak deceleration and deceleration at 2,500 feet altitude.

### SPECIFICATION OF THE INVENTION

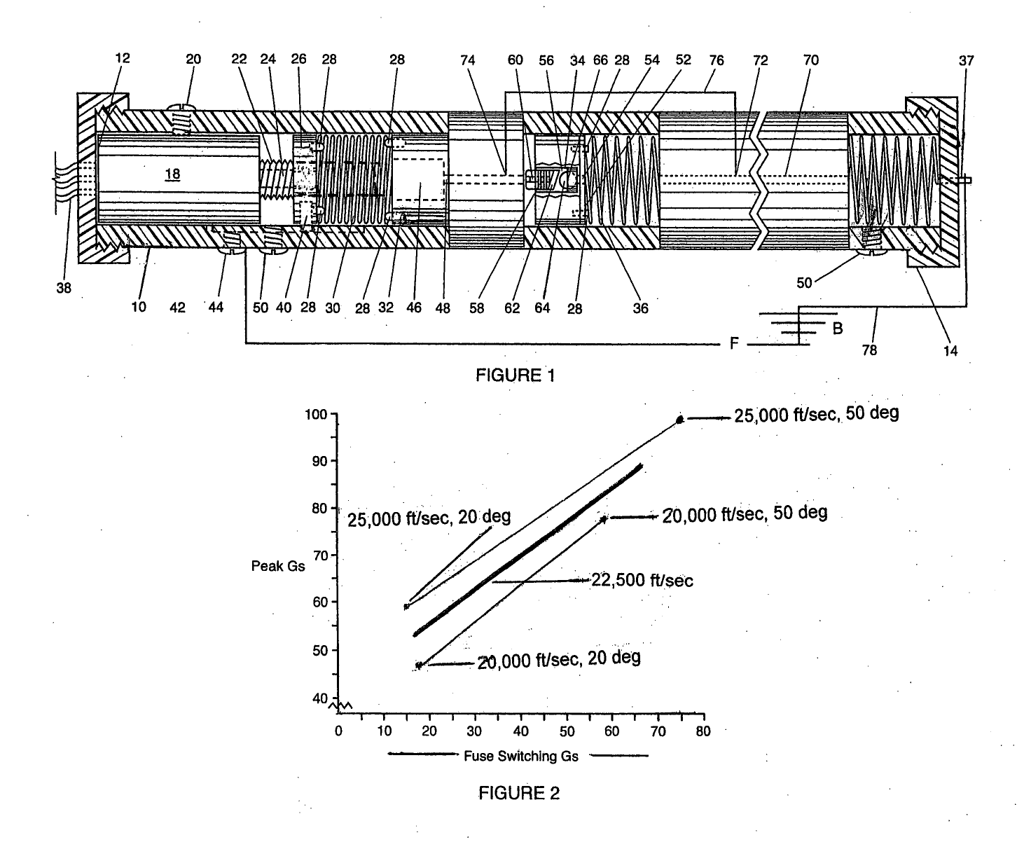

The invention, illustrated in FIG. 1, comprises an electrically insulative cylindrical case 10 filled with nitrogen and hermetically sealed by a threadably and sealably assembled rearward electrically insulative end cap 12 and forward electrically insulative end cap 14 and housing a commercially available remotely programmable bi-directional stepping motor 18 which is fixedly retained at the case's rearward end by set screw 20 and which rotatively drives an elongated forwardly projecting threaded metal rod 22 which is press-fitted to its shortened shaft 24 and which threadably disposes through a disc-shaped metal spring mount 26 which connects, via a pair of eye pins 28, to the rearward end of an electrically conductive and insulated helical extension spring 30 which assembles at its forward end via a pair of eye pins 28 to the rearward end of a slidably disposed copper switching piston 32; and a slidably disposed copper programming piston 34 which is located forwardly of switching piston 32 and which connects via a pair of eye pins 28 to the rearward end of an electrically conductive and insulated helical compression spring 36 whose forward end 37 sealably disposes through forward end cap 14. The programming leads 38 of stepping motor 18 sealably dispose through rearward end cap 12. Spring mount 26 incorporates an axially perpendicular-extending copper pin 40 which slidably disposes in an elongated copper trough 42 embedded in the inner wall of case 10. Terminal screw 44 threadably disposes through the wall of case 10 and abuts trough 42. Switching piston 32 incorporates a rearwardly open cavity 46 which can freely receive the forward end of rod 22. A small hole 47 passes through the forward wall of cavity 46. Screw-closed nitrogen fill ports 48 are located near the rearward and forward ends of case 10.

The peripheries of pistons 32 and 34 would be mercury wetted. Piston 34 incorporates a check valve arrangement disposed in an axially centered cavity 56 closed at its forward end by piston wall 52 and closed at its rearward end by screw 58 which has a small hole 60 passing therethrough. Screw 58 bears against a metal helical compression spring 62 which lightly bears against a spherical copper ball 64 which would normally nest in a hemispherically-formed copper cup 66 which has a small hole (not shown) passing therethrough, in alignment with hole 68 of piston wall 52. Ball 64 and cup 66 would be mercury wetted, so that their engagement would meniscally seal the avenue of nitrogen flow through cavity 56.

As thus designed, programming piston 34 can advance unimpeded (except for spring 36) in inertial response to warhead increasing deceleration. Because of its mercury wetted periphery, the only avenue of nitrogen flow through the piston would be via its cavity 56. As the piston advances, the compressed nitrogen would force ball 64 rearwardly (further compressing spring 62) so that it can flow freely through cavity 56 without impeding the piston. Upon sensing warhead peak deceleration, the piston would stop advancing and compressing the nitrogen, which would stop pressuring ball 64, thereby allowing spring 62 to return ball 64 to its normal nested position in cup 66. As the warhead's deceleration reduces, nitrogen compression acting on the rearward side of ball 64 would reinforce the ball and cup closure, thereby preventing nitrogen flow through cavity 56 and thus causing programming piston 34 to retain its warhead peak deceleration sensing position.

Case 10 would be compression molded and the material would be diallyphthalate, a glass-filled plastic compound noted for its dimensional stability and widely used by the military. Two elongated parallel and comb-shaped copper inserts would be molded in the case, parallel to each other. The insert's teeth, designated generally 70, would be photo-chemically generated and the center-to-center distance between the teeth would be 0.04 inch. However, since the teeth of the inserts would be longitudinally offset, the distance between the center of a tooth and the center of the next forward (or rearward) tooth in the other row would be 0.02 inch. In the molding operation the inserts' teeth would project inwardly beyond the inner wall of the pending case and the tooth joining portions would project outwardly beyond the pending case's outer wall. Following the molding operation, the tooth joining positions would be removed, allowing the outer ends of the teeth to project from the case's outer surface. Trough 42 would be press-fitted in its molded cavity, afterwhich the case's interior would be machined to render the surfaces of trough 42 and teeth 70 flush with the case's wall. The surfaces would then be mercury wetted

In operation, both programming piston 34 and switching piston 32 would advance as the reentering warhead experiences increasing deceleration. Both pistons would stop advancing as the warhead experiences peak deceleration. Because of its check value arrangement, the programming piston would retain its peak deceleration sensing position where it would electrically program the position required for the warhead fuse switching function. The unimpeded switching piston would retract in response to the warhead's post-peak decreasing deceleration, and would close the warhead fuse switching circuit upon reaching the programmed position. When testing the invention, a conduit (not shown) would, via connections to ports 48, be employed to return the programming piston to its rest position.

### Wiring the Invention

FIG. 2 graphically illustrates the relationship between unguided ballistic warhead peak deceleration (g) and respective fuse switching deceleration (g) for the average trajectory and the two extreme trajectories for warhead launch angles between 20 and 50 degrees. These trajectories are those of a representative unguided ballistic warhead system, based on the system's computerized warhead reentry trajectory data. The relationships assume the target altitude would be 2,500 ft. In reference to FIG. 1, the invention's peak deceleration sensing contacts 72 and fuse switching deceleration sensing contacts 74, functionally engagable respectively with programming piston 34 and switching piston 32, would be selected from teeth 70. Peak deceleration contacts 72 would be wired to respective fuse switching deceleration contacts 74 via jumpers 76, only one of which is shown for clarity. The contact selection procedure has been developed but, for brevity, is not disclosed. The invention would be wired on the assumption warheads would traverse the average 22,500 ft/sec trajectory and the fusing altitude would be 2,500 ft. Thus, as shown in FIG. 2, the invention's wiring equation would be gₛ=1.50 gₚ−65.39, where gₚ and gₛ represent warhead peak deceleration and respective fuse switching deceleration. However, because of deceleration sensing errors (explained below) of the invention's pistons, it's effective wiring equation would be gₛ=[pf (1.50 gₚ)−65.39]−sf, where pf and sf represent the respective sensing factors of the programming piston and fuse switching piston.

Stock pile testing of the invention would involve periodic determination of centrifuge-shown differences between actual and sensed acceleration of the programming piston and fuse switching piston. This procedure has been developed but, for brevity, is not disclosed. It will be assumed the latest test showed the programming piston has a 0.97 sensing factor and the fuse switching piston has a 1.04 sensing factor. Accordingly, the invention's resultant effective wired equation would be gₛ=[0.97(1.50 gₚ)−65.39]÷1.05. Application of the equation is as follows.

### Pre-Launch Programming the Invention

It will be assumed the computer-derived expected gₚ and gₛ of a planned warhead mission are 70.20 gs and 40.00 gs, respectively. Substituting the 70.20 gₚ value in the above equation gives a gₛ value of 35.00 gs (5.00 gs less than the expected 40.00 gs). Accordingly, the stepping motor would be remotely stepped to retract the fuse switching piston a distance corresponding to 5.00 gs warhead deceleration change. Thus, in operation, the retracting fuse switching piston would reach the programmed fuse switching contact when sensing 40.00 gs instead of 35.00 gs. It should be borne in mind that the 5.00 gs difference between the programmed and actual fuse switching deceleration values reflects, not only the effect of sensing errors, but also the difference between the mission's warhead launch velocity and the invention's wiring-assumed 22,500 ft/sec launch velocity and the difference between the mission's target altitude and the invention's wiring-assumed 2.500 ft altitude.

### The Invention's Functional Accuracy

Assuming the foregoing compensation for piston sensing errors, the invention's functional accuracy would depend on its wiring (contact selection) errors, the error of the stepping motor's fuse switching piston adjustment function and the programming piston's deceleration resolution error. The pistons' switching increment would be 0.50 g, which would correspond to 0.04 inch travel. Considering the two offset rows of the invention's teeth 70 (FIG. 1), the center-to-center distance would be 0.02 inch. Thus the average error in selecting peak contacts 72 and respective fuse switching contacts 74 would each be 0.005 inch, corresponding to 0.063 g. The stepping motor and its associated threaded rod would be designed to effect a step distance of 0.02 inch. Thus the average error resulting from the stepping function would be 0.01 inch, which would represent 0.13 g. Since, as stated, the contacts would be spaced in 0.50 g increments, the programming piston's average resolution error would be 0.25 g. Assuming each of these functional errors would be normally distributed, the average statistically combined error would be 0.29 g. In an average warhead trajectory of the assumed representative warhead system, this error would correspond to 98 feet average fuse switching altitude error.

Since, as shown in FIG. 2, the invention's wiring would relate fuse switching deceleration to warhead launch angle, and since the relationships would be virtually the same for all launch velocities, errors in achieving the intended launch angle would not significantly affect fuse switching accuracy. As for launch velocity errors, the respective fuse switching altitude errors would average 34 feet per 100 feet launch velocity error. Because of its shock-damped pistons, the invention would be highly reliable in the face of possible countermeasure shock forces. The invention's fuse switching circuit path would be battery B—lead 58—compression spring 36—programming piston 34—programming contact 74—switching piston 32—extension spring 30—spring mount 26—mount pin 40—trough 42—terminal screw 44—lead 60—fusing component F—battery B.

While an exemplary embodiment of the invention has been described in detail, it will be apparent to those skilled in the art that the disclosed embodiment may be modified. Therefore, the foregoing description is to be considered exemplary rather than limiting, and the true scope of the invention is that defined in the following claims.

1. An acceleration switch comprising a cylindrical casing having a fluid filled piston chamber therein aligned with the fore and aft axis of said casing, a first piston slidably received in said chamber and having a first fluid passageway therethrough accommodating unrestricted fluid flow from one side of said piston to the other, first spring means rearwardly assembled to an electrically conductive disc-shaped spring mount and biasing said first piston toward the rearward end of said chamber, said spring mount incorporating an axially perpendicularly extending electrically conductive pin slidably received in an axially oriented electrically conductive trough embedded in the wall of said chamber, a second piston slidably received in said chamber in front of said first piston and having a second fluid passageway therethrough operable to accommodate flow of fluid from one side of said second piston to the other, second spring means biasing said second piston toward the rearward end of said chamber, said pistons being movable within said chamber in inertial response to acceleration applied to said casing, each of said pistons having an electrically conductive body in sliding engagement with the wall of said chamber, a series of electrical contact means located at axially spaced positions in said casing and having exposed contact surfaces flush with the wall of said chamber, and ends projecting from the outer wall of said casing, a first and second said contact means of said series being electrically connected to each other by conductive means and being adapted to be engaged respectively by said electrically conductive bodies of said first and second pistons when said pistons are at respective first and second predetermined locations in said chamber.

2. The invention defined in claim 1 wherein said first and second spring means are electrically conductive and are each electrically connected at one end to the said conductive bodies of the respective said first and second pistons, first and second electrical terminal means electrically connected respectively to said electrically conductive trough and the forward end of said first and second spring means, electrical connection between said first and second terminals being effected when said electrically conductive body of said first piston engages said first contact means and when said conductive of said second piston engages said second contact means.

3. The invention defined in claim 2 further comprising a spring biased ball and socket means disposed in said second fluid passageway of said second piston operable to block flow of said fluid through said second fluid passageway in a direction accommodating rearward movement of said second piston, said second contact means being located to be engaged by said electrically conductive body of said second piston when said second piston is at a forward limit of movement within said chamber representative of a peak acceleration level and said first contact means being located to be engaged by said conductive body of said first piston when said first piston is at a location intermediate its end limits of movement within said chamber representative of an acceleration level less than said peak level.

4. The invention defined in claim 3 further comprising a remotely steppable bi-directional stepping motor mounted at the rearward end of said chamber and whose shaft assembles to an elongated forwardly projecting electrically conductive threaded rod threadably received by said spring mount of said first spring to regulate the inactive axial position of said first piston.
